(19) United States
(12) Patent Application Publication
(10) Pub. No.: US 2026/0112316 A1
(43) Pub. Date: Apr. 23, 2026

(54) DISPLAY DEVICE AND ELECTRONIC DEVICE INCLUDING THE SAME

(71) Applicant: Samsung Display Co., Ltd., Yongin-si (KR)

(72) Inventors: Dae Gwang JANG, Yongin-si (KR); Kyung Su LEE, Yongin-si (KR); Seung Jae LEE, Yongin-si (KR)

(21) Appl. No.: 19/337,598

(22) Filed: Sep. 23, 2025

(30) Foreign Application Priority Data
Oct. 21, 2024 (KR) 10-2024-0144342

(51) Int. Cl. G09G 3/3233; G09G 3/3275

(52) U.S. Cl. CPC G09G 3/3233; G09G 3/3275; G09G 2300/0452; G09G 2300/0842; G09G 2310/0286; G09G 2310/08; G09G 2320/0233; G09G 2320/06; G09G 2330/021

(57) ABSTRACT

A display device comprises a display panel comprising pixels arranged in a first direction, a timing controller for generating output data, based on input image data, a data driver for converting the output data into a data signal and outputting the data signal to at least one output line, a data distributor for supplying the data signal to data lines connected to the display panel, based on any one of a first control signal and a second control signal, which are supplied from the timing controller, and a luminance corrector for generating compensation data for correcting pixels supplied with the data signal relatively late among the pixels.

### CROSS-REFERENCE TO RELATED APPLICATION

The present application claims priority to, and the benefit of, Korean Patent Application No. 10-2024-0144342, filed on Oct. 21, 2024, in the Korean Intellectual Property Office, the entire disclosure of which is incorporated herein by reference.

### BACKGROUND

### 1. Field

The present disclosure generally relates to a display device and an electronic device including the same.

### 2. Description of the Related Art

With the development of information technologies, the importance of a display device which is a connection medium between a user and information increases. Accordingly, display devices, such as a liquid crystal display device and an organic light-emitting display device are increasingly used.

A data driver of a display device supplies data signals to pixels, and the pixels emit light with luminances, based on data signals, thereby displaying an image. The data driver may supply a data signal to the pixels via a data distributor. When the data distributor is included in the display device, the data driver may supply a data signal, using channels of a number that is less than a number of the pixels with respect to a horizontal line. The quality of an image displayed by the display device may be deteriorated while an emission luminance of some pixels is decreased according to an order in which a plurality of pixels are supplied with the data signal.

The above information disclosed in this Related Art section is only for enhancement of understanding of the background of the disclosure and therefore it may contain information that does not form the prior art that is already known in this country to a person of ordinary skill in the art.

### SUMMARY

Embodiments provide a display device and an electronic device, in which the quality of an image displayed by the display device can be improved by compensating for a luminance difference that unintendedly occurs according to a charging deviation of a data signal between a plurality of pixels.

In accordance with an aspect of the present disclosure, there is provided a display device including a display panel including pixels arranged in a first direction, a timing controller configured to generate output data based on input image data, a data driver configured to convert the output data into a data signal, and to output the data signal to at least one output line, a data distributor configured to supply the data signal to data lines connected to the display panel based on any one of a first control signal or a second control signal supplied from the timing controller, and a luminance corrector configured to generate compensation data for correcting one of the pixels supplied with the data signal relatively late.

The pixels may include first pixels including a (1_1)th pixel configured to be supplied with the data signal corresponding to the first control signal, and a (1_2)th pixel configured to be supplied with the data signal corresponding to the second control signal that is different from the first control signal.

The (1_2)th pixel may include the one of the pixels supplied with the data signal relatively late as compared with the (1_1)th pixel.

The pixels may further include second pixels sequentially arranged in the first direction, wherein, in one frame, the second pixels are configured to be supplied with the data signal in a same direction as a direction in which the first pixels are configured to be sequentially supplied with the data signal.

The second pixels may include a (2_1)th pixel configured to be supplied with the data signal corresponding to the first control signal, and a (2_2)th pixel configured to be supplied with the data signal, which corresponds to the second control signal, relatively late as compared with the (2_1)th pixel.

The (1_1)th pixel and the (2_1)th pixel may be adjacent to each other in a second direction crossing the first direction, wherein the (1_2)th pixel and the (2_2)th pixel are adjacent to each other in the second direction.

In a next frame after the one frame, the first pixels and the second pixels may be configured to be sequentially supplied with the data signal in a direction that is opposite to the direction in which the first pixels and the second pixels are configured to be supplied with the data signal in the one frame.

The (1_2)th pixel and the (2_2)th pixel may be configured to be turned off in a first mode, wherein the (1_1)th pixel and the (2_1)th pixel are configured to be turned off in a second mode that is different from the first mode.

The luminance corrector may be configured to control luminances of light emitted by the pixels in the first mode and in the second mode to be substantially equal.

The pixels may further include second pixels sequentially arranged in the first direction, wherein, in one frame, the second pixels are configured to be supplied with the data signal in a direction opposite to a direction in which the first pixels are configured to be sequentially supplied with the data signal.

The second pixels may include a (2_2)th pixel configured to receive the data signal corresponding to the second control signal, and a (2_1)th pixel configured to receive the data signal, which corresponds to the first control signal, relatively late as compared with the (2_2)th pixel.

The (1_1)th pixel and the (2_1)th pixel may be adjacent to each other in a second direction crossing the first direction, wherein the (1_2)th pixel and the (2_2)th pixel are adjacent to each other in the second direction.

In a next frame after the one frame, the first pixels and the second pixels may be configured to be sequentially supplied with the data signal in a direction opposite to the direction in which the first pixels and the second pixels are configured to be supplied with the data signal in the one frame.

In accordance with another aspect of the present disclosure, there is provided an electronic device including a processor configured to provide input image data, and a display device configured to display an image based on the input image data, and including a display panel including pixels arranged in a first direction, a timing controller configured to generate output data based on input image data, a data driver configured to convert the output data into a data signal, and to output the data signal to at least one output line, a data distributor configured to supply the data signal to data lines, which are connected to the display panel, based on any one of a first control signal or a second control signal supplied from the timing controller, and a luminance corrector configured to generate compensation data for correcting one of the pixels supplied with the data signal relatively late.

The pixels may include first pixels including a (1_1)th pixel configured to be supplied with the data signal, corresponding to the first control signal, and a (1_2)th pixel configured to be supplied with the data signal, corresponding to the second control signal different from the first control signal.

The (1_2)th pixel may be configured to receive the data signal relatively late as compared with the (1_1)th pixel.

The pixels may further include second pixels that are sequentially arranged in the first direction, and that are configured to be sequentially supplied with the data signal according to an order in which the second pixels are arranged in a same direction as a direction in which the first pixels are configured to be supplied with the data signal in one frame.

The second pixels may include a (2_1)th pixel configured to receive the data signal corresponding to the first control signal, and a (2_2)th pixel configured to receive the data signal, which corresponds to the second control signal, relatively late as compared with the (2_1)th pixel.

In a next frame after the one frame, the first pixels and the second pixels may be configured to be sequentially supplied with the data signal in a direction opposite to a direction in which the first pixels and the second pixels are configured to be supplied with the data signal in the one frame.

### BRIEF DESCRIPTION OF THE DRAWINGS

Embodiments will now be described more fully hereinafter with reference to the accompanying drawings. However, they may be embodied in different forms, and should not be construed as limited to the embodiments set forth herein. Rather, these embodiments are provided so that this disclosure will be thorough and complete, and will fully convey the scope of the embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a diagram illustrating a display device in accordance with one or more embodiments of the present disclosure.

FIG. 2 is a diagram illustrating a pixel in accordance with one or more embodiments of the present disclosure.

FIG. 3 is a diagram illustrating an arrangement structure of pixels in accordance with one or more embodiments of the present disclosure.

FIG. 4 is a diagram illustrating a scan driver in accordance with one or more embodiments of the present disclosure.

FIG. 5 is a diagram illustrating an order in which a data signal is applied to pixels of a first area and waveforms of signals exchanged between a display panel and a data distributor in accordance with one or more embodiments of the present disclosure.

FIG. 6 is a diagram illustrating luminance of light that the first area outputs for each driving mode in accordance with a comparative example.

FIG. 7 is a diagram illustrating luminance of light that the first area outputs for each driving mode in accordance with one or more embodiments of the present disclosure.

FIG. 8 is a diagram illustrating an order in which a data signal is applied to the pixels of the first area for each frame and the first area viewed by a user of the display device in accordance with one or more embodiments of the present disclosure.

FIG. 9 is a diagram illustrating an order in which a data signal is applied to pixels of a first area and waveforms of signals exchanged between the display panel and the data distributor in accordance with one or more embodiments of the present disclosure.

FIG. 10 is a diagram illustrating luminance of light that the first area outputs for each driving mode in accordance with a comparative example.

FIG. 11 is a diagram illustrating luminance of light that the first area outputs for each driving mode in accordance with one or more embodiments of the present disclosure.

FIG. 12 is a diagram illustrating an order in which a data signal is applied to the pixels of the first area for each frame and the first area viewed by the user of the display device in accordance with one or more embodiments of the present disclosure.

FIG. 13 is a block diagram illustrating an electronic device in accordance with embodiments of the present disclosure.

FIG. 14 is a view illustrating an example in which the electronic device shown in FIG. 13 is implemented as a smartphone.

FIG. 15 is a view illustrating an example in which the electronic device shown in FIG. 13 is implemented as a tablet PC.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto. Embodiments disclosed herein should not be construed as limited to the illustrated shapes of elements, layers, or regions, but are to include deviations in shapes that result from, for instance, manufacturing.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection.

For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XY, YZ, and XZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B”may include A, B, or A and B.

Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5 % of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.” Furthermore, the expression “being the same” may mean “being substantially the same”. In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

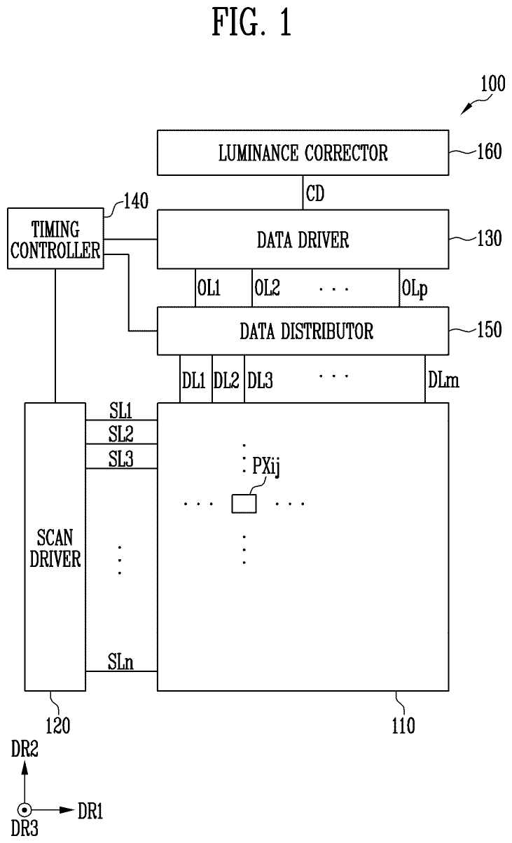

FIG. 1 is a diagram illustrating a display device in accordance with one or more embodiments of the present disclosure.

Referring to FIG. 1, a display device 100 in accordance with one or more embodiments of the present disclosure may include a display panel 110, a scan driver 120, a data driver 130, a timing controller 140, a data distributor 150, and a luminance corrector 160.

The timing controller 140 may control overall operations of the display device 100. The timing controller 140 may receive input image data for each frame and a control signal from an external processor. The timing controller 140 may generate output data by correcting the input image data, and may supply the output data to the data driver 130. Also, the timing controller 140 may control the scan driver 120, the data driver 130, and the data distributor 150, corresponding to the control signal.

The data driver 130 may generate data signals corresponding to output data, and may provide the data signals to output lines OL1, OL2, . . . , and OLp (p being a natural number of 3 or more and m or less). For example, the data driver 130 may sample output data using a clock signal, and may supply data signals corresponding to the output data to the output lines OL1 to OLp. The data driver 130 may supply a plurality of data signals to each of the output lines OL1 to OLp during one horizontal period.

The data distributor 150 may be connected to the data driver 130 via the output lines OL1 to OLp. The data distributor 150 may be connected to pixels via data lines DL1, DL2, DL3, . . . , and DLm (m is a natural number of 4 or more). The data distributor 150 may include a plurality of demuxes (or demultiplexers).

The data distributor 150 may selectively connect the output lines OL1 to OLp to the data lines DL1 to DLm. In an example, the data distributor 150 may electrically connect each of the output lines OL1 to OLp to two or more data lines (two or more of DL1 to DLm) during one horizontal period under the control of the timing controller 140. Each of the data lines DL1 to DLm may receive a data signal an output line (any one of OL1 to OLp) connected thereto during one horizontal period.

The scan driver 120 may be supplied with a clock signal and a scan start signal from the timing controller 140. The scan driver 120 may supply an enable scan signal to scan lines SL1, SL2, SL3, . . . , and SLn while shifting the scan start signal, corresponding to the clock signal (n is a natural number greater than 4). The enable scan signal may correspond to a gate-on voltage of a transistor. In an example, when the enable scan signal is supplied to a P-type transistor, the enable scan signal may be set to a logic low voltage.

The display panel 110 may include pixels connected to the scan lines SL1 to SLn and the data lines DL1 to DLm. Each pixel PXij may be connected to a corresponding data line and a corresponding scan line (i and j are natural numbers greater than 1). The pixel PXij may mean a pixel connected to an ith scan line and a jth data line.

The luminance corrector 160 may be connected to the data driver 130. The luminance corrector 160 may transfer compensation data CD to the data driver 130.

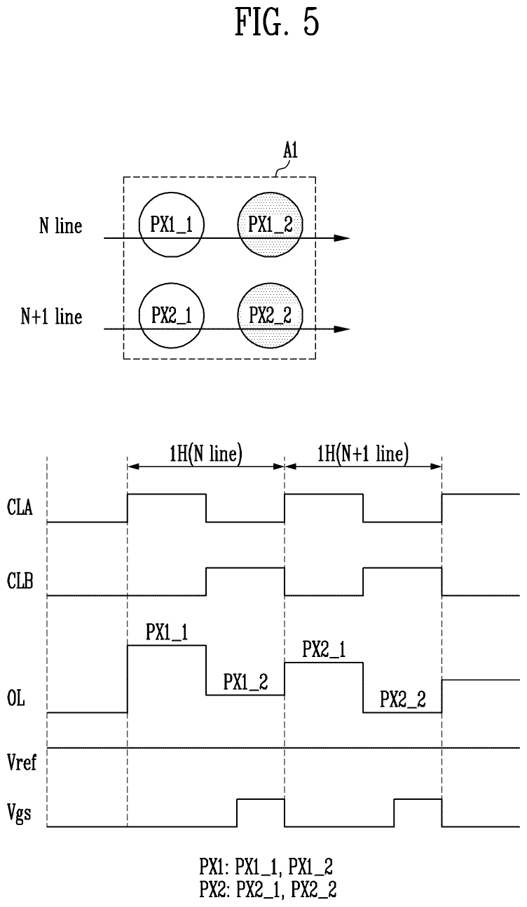

The compensation data CD may be signal for controlling a luminance of at least one pixel PXij among a plurality of pixels PXij. For example, the data driver 130 may increase a luminance of at least one pixel among the plurality of pixels PXij, based on the transferred compensation data CD. This will be described in detail later with reference to FIGS. 5 to 7.

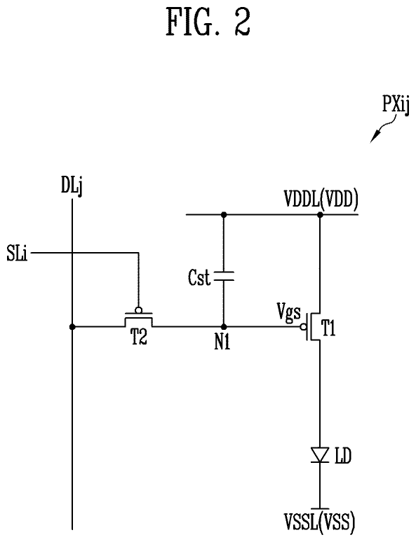

FIG. 2 is a diagram illustrating a pixel in accordance with one or more embodiments of the present disclosure. The present disclosure is not limited to the pixel shown in FIG. 2, and pixels having various circuit configurations currently known in the art may be included in the display panel 110.

Referring to FIG. 2, the pixels of the display panel 110 (see FIG. 1) may be commonly connected to a first power line VDDL and a second power line VSSL. A first driving power source VDD may be supplied to the first power line VDDL, and a second driving power source VSS may be supplied to the second power line VSSL. When the pixel PXij is set to be in an emission state, the first driving power source VDD may be set to a voltage higher than a voltage of the second driving power source VSS.

A pixel PXij in accordance with one or more embodiments of the present disclosure may be a pixel for emitting light of a first color. Pixels emitting light of a second color or a third color may be configured substantially identically to the pixel PXij except a light-emitting element LD, and therefore, overlapping descriptions will be omitted.

For example, the first color may be one of red, green, or blue. The second color may be one of red, green, or blue that is not the first color, and the third color may be the remaining one of red, green, or blue that is not the first color or the second color. In addition, magenta, cyan, and yellow may be used as the first to third colors, instead of red, green, and blue.

The pixel PXij may include a plurality of transistors T1 and T2, a storage capacitor Cst, and a light-emitting element LD.

The transistors are implemented with a P-type transistor (e.g., a PMOS transistor). However, those skilled in the art may design a pixel circuit having the same function, using an N-type transistor (e.g., an NMOS transistor).

A first electrode of a first transistor T1 may be connected to a first power line VDDL, and a second electrode of the first transistor T2 may be connected to a first electrode (or anode electrode) of the light-emitting element LD. In addition, a gate electrode of the first transistor T1 may be connected to a first node N1. The first transistor T1 may control an amount of current supplied from the first power line VDDL to a second power line VSSL via the light-emitting element LD corresponding to a voltage of the first node N1. For example, a gate voltage Vgs may be applied to the gate electrode of the first transistor T1 through the first node N1. Accordingly, the first transistor T1 may supply a current having a selected magnitude to the first electrode of the light-emitting element LD, based on a magnitude of the gate voltage Vgs.

A first electrode of a second transistor T2 may be connected to a data line DLj, and a second electrode of the second transistor T2 may be connected to the first node N1. In addition, a gate electrode of the second transistor T2 may be connected to a scan line SLi. The second transistor T2 may be turned on when an enable scan signal is supplied to the scan line SLi to electrically connect the data line DLj and the first node N1 to each other.

The first transistor T1 and the second transistor T2 may be implemented with a P-type transistor and/or an N-type transistor. In embodiments, the first transistor T1 and the second transistor T2 may include a Metal Oxide Silicon Field Effect Transistor (MOSFET). In embodiments, the first transistor T1 and the second transistor T2 may include an amorphous silicon semiconductor, a monocrystalline silicon semiconductor, a polycrystalline silicon semiconductor, an oxide semiconductor, and the like.

The storage capacitor Cst may be connected between the first power line VDDL and the first node N1. The storage capacitor Cst may store the voltage of the first node N1.

The first electrode (or anode electrode) of the light-emitting element LD may be connected to the second electrode of the first transistor T1, and a second electrode (or cathode electrode) of the light-emitting element LD may be connected to the second power line VSSL. The light-emitting element LD may emit light of the first color with a selected luminance corresponding to an amount of current supplied from the first transistor T1.

In some embodiments, the gate voltage Vgs may be supplied through the data line DLj. The gate voltage Vgs may unintendedly vary according to an order in which the gate voltage Vgs is supplied to the data line DLj among the plurality of data lines DL1 to DLm. Accordingly, the amount of current supplied from the first transistor T1 may vary, and an emission luminance of the light-emitting element LD may vary. That is, it may be suitable to correct the emission luminance of the light-emitting element LD.

The light-emitting element LD may be configured as an organic light-emitting diode, or may be configured as an inorganic light-emitting diode, such as a micro LED (light-emitting diode) or a quantum dot light-emitting diode. Also, the light-emitting element LD may be an element configured with a combination of an organic material and an inorganic material. Only one light-emitting element LD is illustrated. However, a plurality of sub-light-emitting elements may be connected in series, parallel, or series/parallel to each other, and therefore, the light-emitting element may be replaced therewith.

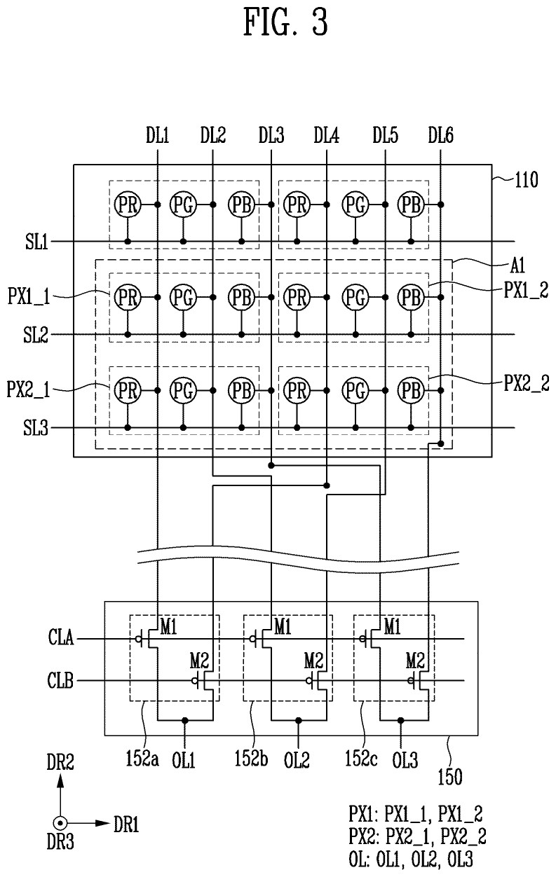

FIG. 3 is a diagram illustrating an arrangement structure of pixels in accordance with one or more embodiments of the present disclosure.

Referring to FIG. 3, the display panel 110 may include a plurality of pixels. For example, the display panel 110 may include a first area A1 in which first pixels PX1 and second pixels PX2 are located in a first direction DR1. For convenience of description, the pixels located in the first area A1 will be mainly described.

The first pixels PX1 may include a (1_1)th pixel PX1_1 and a (1_2)th pixel PX1_2, which are sequentially arranged in the first direction DR1. The second pixels PX2 may include a (2_1)th pixel PX2_1 and a (2_2)th pixel PX2_2, which are sequentially arranged in the first direction DR1.

Each of the first pixels PX1 and the second pixels PX2 may include a red pixel PR, a green pixel PG, and a blue pixel PB. In some embodiments, the pixels may be arranged in a PenTile™ form (PenTile™ and PENTILE™ being registered trademarks of Samsung Display Co., Ltd., Republic of Korea), but the present disclosure is not limited thereto.

The red pixel PR, the green pixel PG, and the blue pixel PG may be sequentially arranged in the first direction DR1. For example, the red pixel PR, the green pixel PG, and the blue pixel PG may be arranged along a scan line SL1 to SL3 (or along a direction of the scan line).

Each of the first pixels PX1 and the second pixels PX2 may include a singular red pixel PR, a singular green pixel PG, and a singular blue pixel PB. For example, the (1_1)th pixel PX1_1 may include a red pixel PR, a green pixel PG, and a blue pixel PB, which are located between a first scan line SL1 and a second scan line SL2. The (2_1)th pixel PX2_1 may include a red pixel PR, a green pixel PG, and a blue pixel PB, which are located between the second scan line SL2 and a third scan line SL3.

In addition, the (1_2)th pixel PX1_2 may include a red pixel PR, a green pixel PG, and a blue pixel PB, which are located between the first scan line SL1 and the second scan line SL2. The (2_2)th pixel PX2_2 may include a red pixel PR, a green pixel PG, and a blue pixel PB, which are located between the second scan line SL2 and the third scan line SL3.

Ones of the red pixels PR, green pixels PG, and blue pixels PB that are located on the same vertical line (e.g., in a same column) may be connected to the same data line. In an example, the red pixel PR of the (1_1)th pixel PX1_1 and the red pixel PR of the (2_1)th pixel PX2_1, which are located on the same vertical line, may be connected to the same first data line DL1. However, this is merely illustrative, and the present disclosure is not limited thereto. For example, any one of the red pixels PR, the green pixels PG, or the blue pixels PB, each of which are located on the same vertical line, may be alternately connected to different data lines.

Ones of the red pixels PR, green pixels PG, and blue pixels PB, which are located on the same horizontal line (e.g., in a same row), may be connected to the same scan line. For example, the red pixel PR of the (1_1)th pixel PX1_1 and the green pixel PG of the (1_1)th pixel PX1_1 may be connected to the same second scan line SL2. However, this is merely illustrative, and the present disclosure is not limited thereto. For example, any one of the red pixels PR, the green pixels PG, or the blue pixels PB, which are located on the same horizontal line, may be alternately connected to different scan lines.

The data distributor 150 may include a plurality of demuxes 152a, 152b, and 152c. Each of the demuxes 152a, 152b, and 152c may transfer two data signals supplied to any one of a plurality of output lines OL to two data lines (e.g., two of DL1 to DL6). That is, each of the demuxes 152a, 152b, and 152c may be a 1:2 demultiplexer. In some embodiments, this is merely illustrative, and the present disclosure is not limited thereto. For example, each of the demuxes 152a, 152b, and 152c may transfer three data signals supplied to a corresponding one of the plurality of output lines OL to three data lines. That is, each of the demuxes 152a, 152b, and 152c may be a 1:3 demultiplexer. However, for convenience of description, it is described that each of the demuxes 152a, 152b, and 152c is a 1:2 demultiplexer.

However, the following description may be applied even when each of the demuxes 152a, 152b, and 152c is a 1:3 demultiplexer.

A first demux 152a may time-divide a data signal from a first output line OL1, and may supply the time-divided data signal to the first data line DL1 and a second data line DL2. A second demux 152b may time-divide a data signal from a second output line OL2, and may supply the time-divided data signal to a third data line DL3 and a fourth data line DL4. A third demux 152c may time-divide a data signal from a third output line OL3, and may supply the time-divided data signal to a fifth data line DL5 and a sixth data line DL6.

Each of the demuxes 152a, 152b, and 152c may include a first transistor M1 and a second transistor M2. First transistors M1 of the demuxes 152a, 152b, and 152c may be connected to the output lines OL1 to OL3 and to the first to third data lines DL1 to DL3, respectively. The first transistors M1 may be turned on by an enable first control signal CLA supplied from the timing controller 140. The enable first control signal CLA may have a gate-on voltage such that the first transistor M1 can be turned on. In an example, when the first transistor M1 is a P-type transistor, the enable first control signal CLA may have a logic low level.

Second transistors M2 of the demuxes 152a, 152b, and 152c may be connected between the output lines OL1 to OL3 and to the fourth to sixth data lines DL4 to DL6, respectively. The second transistors M2 may be turned on by an enable second control signal CLB supplied from the timing controller 140. The enable second control signal CLB may have a gate-on voltage such that the second transistor M2 can be turned on. In an example, when the second transistor M2 is a P-type transistor, the enable second control signal CLB may have a logic low level.

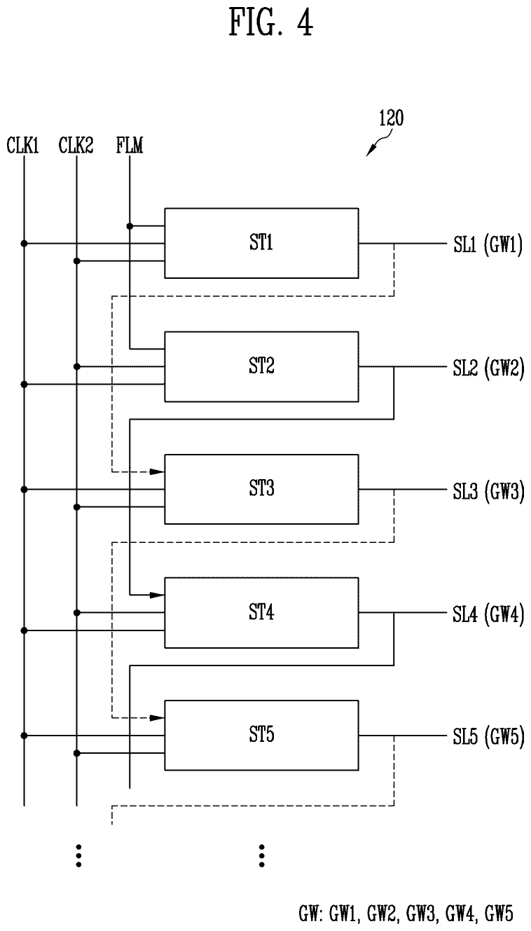

FIG. 4 is a diagram illustrating a scan driver in accordance with one or more embodiments of the present disclosure.

Referring to FIG. 4, a scan driver 120 in accordance with one or more embodiments of the present disclosure may include a stage circuits ST1, ST2, ST3, ST4, ST5, . . .

Each of the stage circuits ST1 to ST5 may be electrically connected to one scan line (one of SL1, SL2, SL3, SL4, or SL5). Each of the stage circuits ST1 to ST5 may supply a scan signal GW to a scan line (one of SL1 to SL5) connected thereto.

The stage circuits ST1 to ST5 may be supplied with a clock signal CLK1 and CLK2. Each of odd-numbered stage circuits ST1, ST3, ST5, . . . may be supplied with a first clock signal CLK1 through a first input terminal, and may be supplied with a second clock signal CLK2 through a second input terminal. Each of even-numbered stage circuits ST2, ST4, . . . may be supplied with the second clock signal CLK2 through a first input terminal, and may be supplied with the first clock signal CLK1 through a second input terminal.

A first stage circuit ST1 may be supplied with a start signal FLM, and may output a scan signal GW1 while shifting the start signal FLM, corresponding to the clock signal CLK1 and CLK2. A carry signal (or the scan signal GW1) output from the first stage circuit ST1 may be supplied to a third stage circuit ST3. That is, each of the odd-numbered stage circuits ST3, ST5, . . . may receive a carry signal input from a previous odd-numbered stage circuit. However, this is merely illustrative, and the present disclosure is not limited thereto. For example, each of the odd-numbered stage circuits ST3, ST5, . . . may receive a carry signal input from a previous stage circuit.

A second stage circuit ST2 may be supplied with the start signal FLM, and may output a scan signal GW2 while shifting the start signal FLM, corresponding to the clock signal CLK1 and CLK2. A carry signal (or the scan signal GW2) output from the second stage circuit ST2 may be supplied to a fourth stage circuit ST4. That is, each of the even-numbered stage circuits ST4, . . . may receive a carry signal input from a previous even-numbered stage circuit. However, this is merely illustrative, and the present disclosure is not limited thereto. For example, each of the even-numbered stage circuits ST4, . . . may receive a carry signal input from a previous stage circuit.

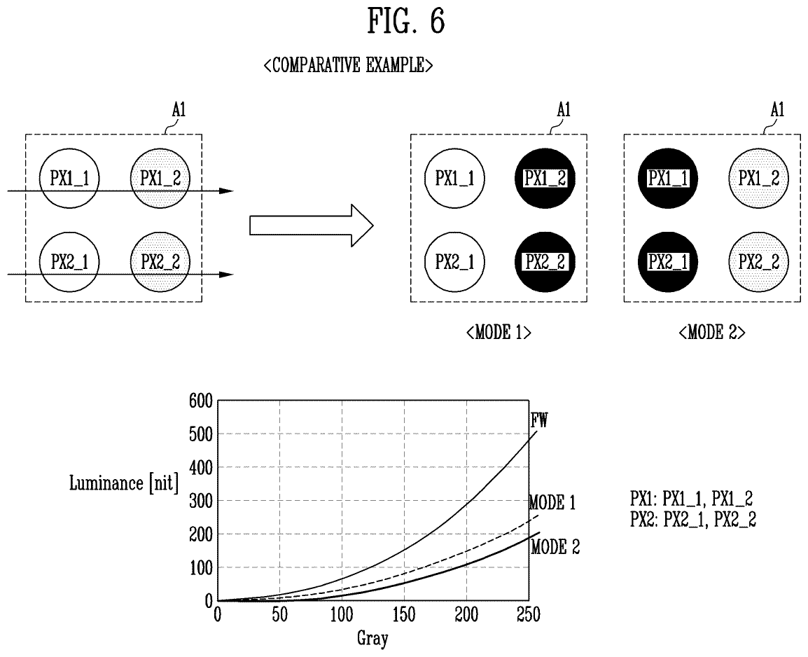

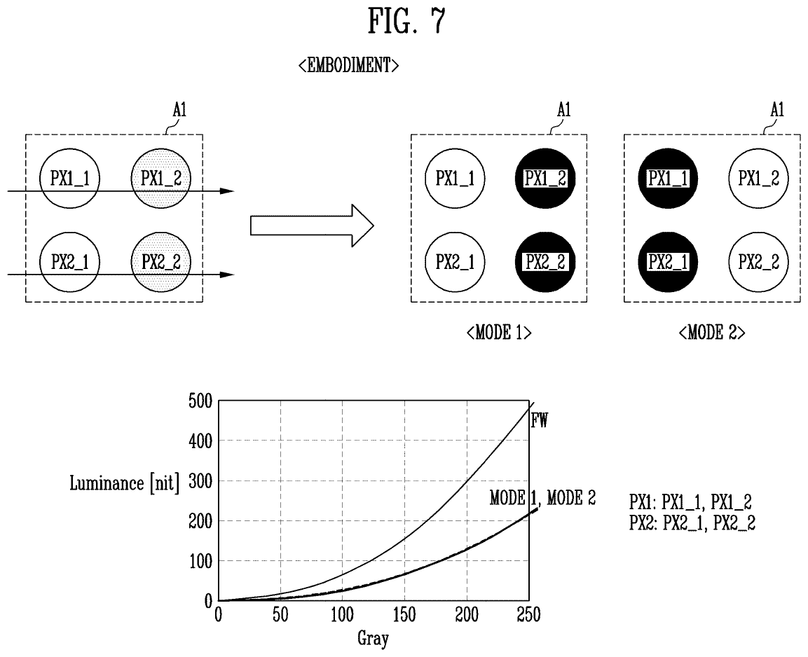

FIG. 5 is a diagram illustrating an order in which a data signal is applied to pixels of a first area, and waveforms of signals exchanged between the display panel and the data distributor, in accordance with one or more embodiments of the present disclosure. FIG. 6 is a diagram illustrating luminance of light that the first area outputs for each driving mode in accordance with a comparative example. FIG. 7 is a diagram illustrating luminance of light that the first area outputs for each driving mode in accordance with one or more embodiments of the present disclosure.

Referring to FIG. 5, each of a first signal CLA and a second control signal CLB may respectively supply signals having the same waveform to pixels located on an nth horizontal line and an (n+1)th horizontal line. For example, the first control signal CLA, when pixels located on the nth horizontal line are driven, may have a high level during a first half of a first time interval 1H, and may have a low level during the other half of the first time interval 1H. The first control signal CLA, when pixels located on the (n+1)th horizontal line are driven, may have a waveform equal to a waveform of the first control signal CLA when the pixels located on the nth horizontal line are driven.

The second control signal CLB, when the pixels located on the nth horizontal line are driven, may have a low level during the first half of the first time interval 1H, and may have a high level during the other half of the first time interval 1H. The second control signal CLB, when the pixels located on the (n+1)th horizontal line are driven, may have a waveform equal to a waveform of the second control signal CLB when the pixels located on the nth horizontal line are driven.

A data signal may be supplied to first pixels PX1 located on the nth horizontal line of the first area A1, and then supplied to second pixels PX2 located on the (n+1)th horizontal line. The first pixels PX1 may sequentially receive the data signal according to an order in which the first pixels PX1 are arranged in the first direction DR1 (see FIG. 3). For example, after a (1_1)th pixel PX1_1 is supplied with the data signal, a (1_2)th pixel PX1_2 may be supplied with the data signal.

Each of the first pixels PX1 and the second pixels PX2 may receive a data signal transferred from at least one first to third output lines OL1 to OL3 among a plurality of output lines OL. For example, a selected data signal may be transferred to the (1_1)th pixel PX1_1 and the (1_2)th pixel PX1_2 through the first to third output lines OL1 to OL3 according to a grayscale to be expressed. As described above in FIG. 2, a gate voltage Vgs (see FIG. 2) supplied to a light-emitting element LD (see FIG. 2) of the (1_1)th pixel PX1_1 may be different from a gate voltage Vgs supplied to a light-emitting element LD of the (1_2)th pixel PX1_2. In other words, a difference in absolute value between the gate voltage of the light-emitting element LD of the (1_2)th pixel PX1_2 and a reference voltage Vref may be less than a difference in absolute value between the gate voltage Vgs of the light-emitting element LD of the (1_1)th pixel PX1_1 and the reference voltage Vref. Accordingly, the light-emitting element LD of the (1_2)th pixel PX1_2 may emit light with a relatively low grayscale (or luminance).

The second pixels PX2 located on the (n+1)th horizontal line may be sequentially supplied with the data signal according to an order in which the second pixels PX2 are arranged in the first direction DR1 (see FIG. 3). For example, a (2_1)th pixel PX2_1 may be driven by the first control signal CLA, and then a (2_2)th pixel PX2_2 may be driven by the second control signal CLB.

Each of the (2_1)th pixel PX2_1 and the (2_2)th pixel PX2_2 may receive the data signal transferred from at least one first to third output line OL1 to OL3 among the plurality of output lines OL. That is, a selected data signal may be transferred to the (2_1)th pixel PX2_1 and the (2_2)th pixel PX2_2 through the first to third output lines OL1 to OL3 according to a grayscale to be expressed. As described above in FIG. 2, a gate voltage Vgs supplied to a light-emitting element LD of the (2_1)th pixel PX2_1 may be different from a gate voltage Vgs supplied to a light-emitting element LD of the (2_2)th pixel PX2_2. In other words, a difference in absolute value between the gate voltage Vgs of the light-emitting element LD of the (2_2)th pixel PX2_2 and the reference voltage Vref may be less than a difference in absolute value between the gate voltage Vgs of the light-emitting element LD of the (2_1)th pixel PX2_1 and the reference voltage Vref. Accordingly, the light-emitting element LD of the (2_2)th pixel PX2_2 may emit light with a relatively low grayscale (or luminance).

Referring to FIG. 6, the pixels of the first area A1 may be driven in a first mode and a second mode. In the first mode, only pixels in a column direction among the pixels of the first area A1 may be driven. For example, in the first mode, the (1_1)th pixel PX1_1 and the (2_1)th pixel PX2_1 may be driven, and the (1_2)th pixel PX1_2 and the (2_2)th pixel PX2_2 may not be driven (e.g., may be turned off).

In addition, in the second mode, only pixels in a column direction among the pixels of the first area A1 may be driven. For example, in the second mode, the (1_1)th pixel PX1_1 and the (2_1)th pixel PX2_1 may not be driven (e.g., may be turned off), and the (1_2)th pixel PX1_2 and the (2_2)th pixel PX2_2 may be driven.

In accordance with the comparative example, a luminance of the first area A1 in the first mode and a luminance of the first area A1 in the second mode may be different from each other. For example, the luminance of the first area A1 in the first mode may be higher than the luminance of the first area A1 in the second mode.

Accordingly, the quality of an image displayed by the display panel 110 may be deteriorated.

In some embodiments, the first area A1 may be driven with full white. In other words, the pixels located in the first area A1 may all be driven to express white. Power consumption suitable to drive the first area A1 (or the display panel 110 (see FIG. 1)) may be relatively increased. On the other hand, when the pixels located in the first area A1 are driven in the first mode (or the second mode), power consumption suitable to drive the first area A1 (or the display panel 110) may be relatively decreased.

Referring to FIG. 7, a luminance of the first area A1 in the first mode and a luminance of the first area A1 in the second mode may be the same. For example, the luminance corrector 160 (see FIG. 1) may correct the (1_2)th pixel PX1_2 and the (2_2)th pixel PX2_2. In other words, the luminance corrector 160 may generate compensation data CD, such that the data driver 130 or the data distributor 150 increases a luminance of light expressed by the (1_2)th pixel PX1_2 and the (2_2)th pixel PX2_2, and the luminance of light expressed by the (1_2)th pixel PX1_2 and the (2_2)th pixel PX2_2 of the display panel 110 may be increased. Accordingly, the luminance of the first area A1 in the first mode and the luminance of the first area A1 in the second mode are the same, and the quality of an image displayed by the display panel 110 can be relatively improved.

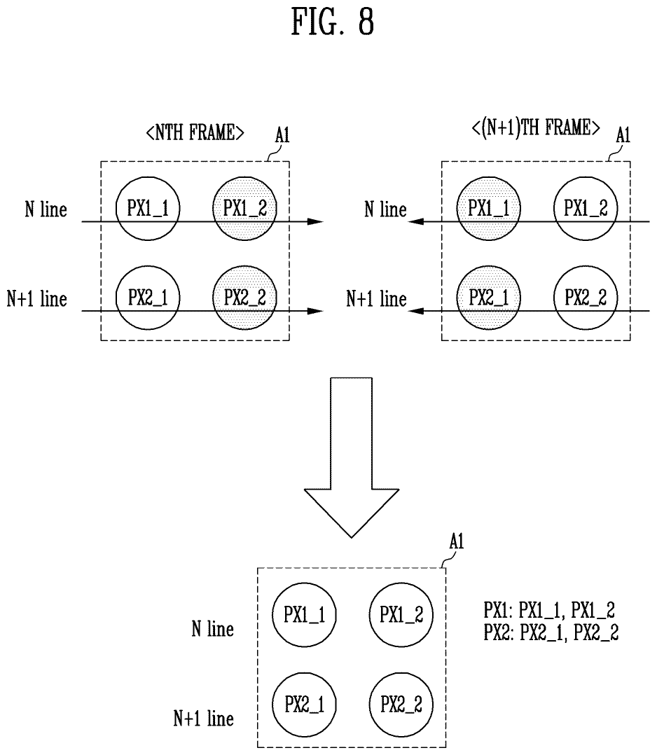

FIG. 8 is a diagram illustrating an order in which a data signal is applied to the pixels of the first area for each frame, and the first area viewed by a user of the display device, in accordance with one or more embodiments of the present disclosure.

Referring to FIG. 8, in an nth frame as a selected one frame, a data signal may be applied to the first pixels PX1 located on the nth horizontal line, and then may be applied to the second pixels PX2 located on the (n+1)th horizontal line. In the nth frame, the luminance of light output from the (1_2)th pixel PX1_2 and the (2_2)th pixel PX2_2 may be relatively low.

The data distributor 150 (see FIG. 3) may supply a data signal to the first pixels PX1 and the second pixels PX2 in an (n+1)th frame in a direction opposite to a direction in which the data distributor 150 supplies the data signal to the first pixels PX1 and the second pixels PX2 in the nth frame. For example, the data distributor 150 may change a time at which the data signal is supplied and may change an order in which the data signal is supplied, based on the control signal of the timing controller 140 (see FIG. 1). Accordingly, the data distributor 150 may change the direction in which the data distributor 150 supplies the data signal to the first pixels PX1 and the second pixels PX2 in the (n+1)th frame, and the luminance of light output from the (1_1)th pixel PX1_1 and the (2_1)th pixel PX2_1 may become low.

Luminances of an image that is output from the first pixels PX1 and the second pixels PX2, and that is viewed by the user of the display device 100 (see FIG. 1) may be uniform. For example, the data distributor 150 may alternately change, for each frame, the direction in which the data distributor 150 supplies the data signal to the first pixels PX1 and the second pixels PX2. Accordingly, a risk can be reduced or prevented such that the quality of an image will be deteriorated as luminances of light, which are expressed by one pixel of the first area A1 (e.g., the (1_1)th pixel PX1_1 in the nth frame) and another pixel of the first area A1 (e.g., the (1_2)th pixel PX1_2 in the nth frame) are different from each other, and an optimum image can be displayed to the user of the display device 100.

The data distributor 150 may alternately change, for each frame, the direction in which the data distributor 150 supplies the data signal to the first pixels PX1 and the second pixels PX2, and an emission luminance of at least one pixel among the first pixels PX1 and PX2 may be corrected according to the luminance corrector 160. In other words, the luminance corrector 160 may correct an emission luminance of the (1_2)th pixel PX1_2 and the (2_2)th pixel PX2_2 in the nth frame, and may correct an emission luminance of the (1_1)th pixel PX1_1 and the (2_1)th pixel PX2_1 in the (n+1)th frame. Accordingly, the display device 100 can display an image having relatively further improved quality.

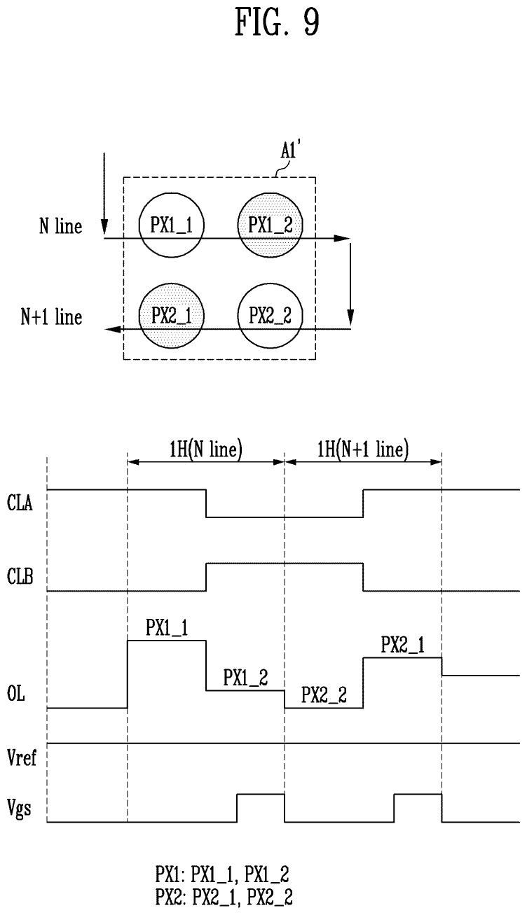

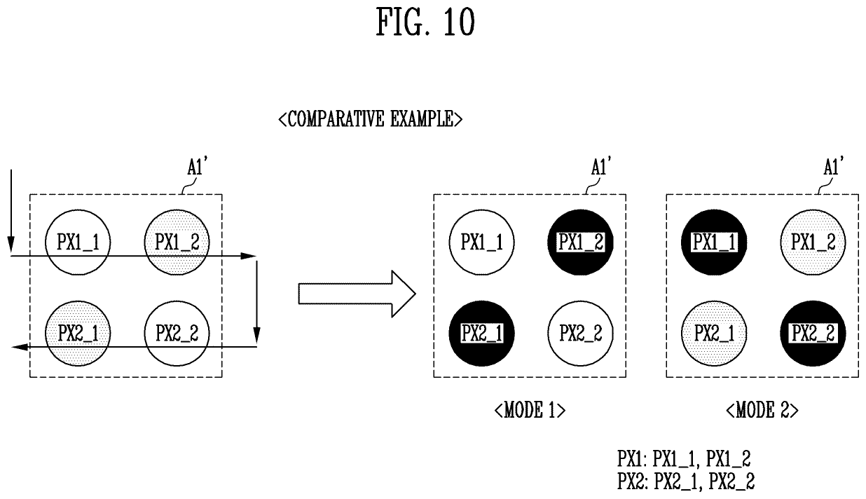

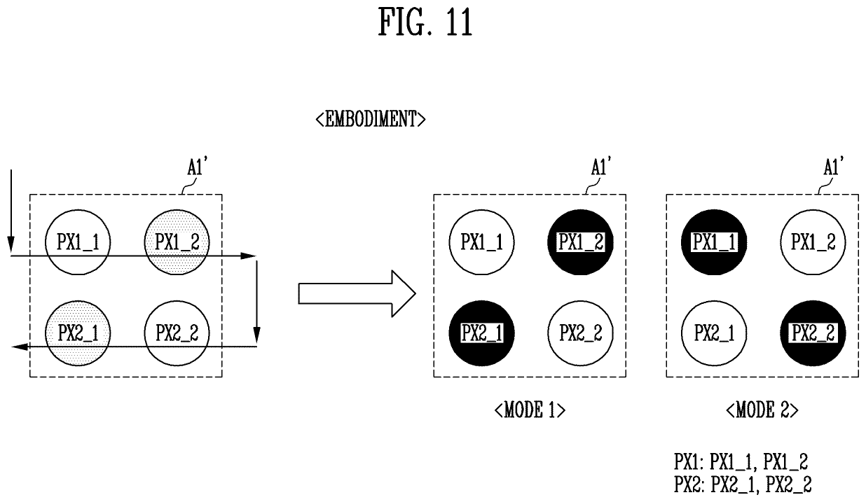

FIG. 9 is a diagram illustrating an order in which a data signal is applied to pixels of a first area, and waveforms of signals exchanged between the display panel and the data distributor, in accordance with one or more embodiments of the present disclosure. FIG. 10 is a diagram illustrating luminance of light that the first area outputs for each driving mode in accordance with a comparative example. FIG. 11 is a diagram illustrating luminance of light that the first area outputs for each driving mode in accordance with one or more embodiments of the present disclosure.

Referring to FIG. 9, a first control signal CLA and a second control signal CLB may supply signals having different waveforms when pixels located on an nth horizontal line are driven, and when pixels located on an (n+1)th horizontal line are driven. For example, the first control signal CLA when the pixels located on the nth horizontal line are driven may have a signal having a high level during a first half of a first time interval 1H, and may have a signal having a low level during the other half of the first time interval 1H. On the other hand, the first control signal CLA when the pixels located on the (n+1)th horizontal line may have a signal having a low level during the first half of the first time interval 1H, and may have a signal having a high level during the other half of the first time interval 1H.

The second control signal CLB when the pixels located on the nth horizontal line are driven may have a signal having a low level during the first half of the first time interval 1H, and may have a signal having a high level during the other half of the first time interval 1H. On the other hand, the second control signal CLB when the pixels located on the (n+1)th horizontal line are driven may have a signal having a high level during the first half of the first time interval 1H, and may have a signal having a low level during the other half of the first time interval 1H.

After a data signal may be supplied to first pixels PX1 located on the nth horizontal line of a first area A1′, and then may be supplied to second pixels PX2 located on the (n+1)th horizontal line of the first area A1′ The first pixels PX1 may be sequentially supplied with the data signal according to an order in which the first pixels PX1 are arranged in the first direction DR1 (see FIG. 3), and the second pixels PX2 may be sequentially supplied with the data signal according to an order in which the second pixels PX2 are arranged in the opposite direction of the first direction DR1. For example, after a (1_1)th pixel PX1_1 is supplied with the data signal, the (1_2)th pixel PX1_2 may be supplied with the data signal. After that, a (2_2)th pixel PX2_2 may be supplied with the data signal, and a (2_1)th pixel PX2_1 may be supplied with the data signal.

Each of the first pixels PX1 and the second pixels PX2 may receive a data signal transferred from at least one first to third output lines OL1 to OL3 among a plurality of output lines OL. For example, a selected data signal may be transferred to the (1_1)th pixel PX1_1 and the (1_2)th pixel PX1_2 through the first to third output lines OL1 to OL3 according to a grayscale to be expressed. As described above in FIG. 2, a gate voltage Vgs (see FIG. 2) supplied to a light-emitting element LD (see FIG. 2) of the (1_1)th pixel PX1_1 may be different from a gate voltage Vgs supplied to a light-emitting element LD of the (1_2)th pixel PX1_2. In other words, a difference in absolute value between the gate voltage of the light-emitting element LD of the (1_2)th pixel PX1_2 and a reference voltage Vref may be less than a difference in absolute value between the gate voltage Vgs of the light-emitting element LD of the (1_1)th pixel PX1_1 and the reference voltage Vref. Accordingly, the light-emitting element LD of the (1_2)th pixel PX1_2 may emit light with a relatively low grayscale (or luminance).

In addition, a gate voltage Vgs supplied to a light-emitting element LD of the (2_2)th pixel PX2_2 may be different from a gate voltage Vgs supplied to a light-emitting element LD of the (2_1)th pixel PX2_1. In other words, a difference in absolute value between the gate voltage Vgs of the light-emitting element LD of the (2_1)th pixel PX2_1 and the reference voltage Vref may be less than a difference in absolute value between the gate voltage Vgs of the light-emitting element LD of the (2_2)th pixel PX2_2 and the reference voltage Vref. Accordingly, the light-emitting element LD of the (2_1)th pixel PX2_1 may emit light with a relatively low grayscale (or luminance).

Referring to FIG. 10, the pixels of the first area A1′ may be driven in a first mode and in a second mode. In the first mode, the (1_1)th pixel PX1_1 and the (2_2)th pixel PX2_2 may be driven, and the (1_2)th pixel PX1_2 and the (2_1)th pixel PX2_1 may not be driven. In the second mode, the (1_2)th pixel PX1_2 and the (2_1)th pixel PX2_1 may be driven, and the (1_1)th pixel PX1_1 and the (2_2)th pixel PX2_2 may not be driven. In accordance with the comparative example, a luminance of the first area A1′ in the first mode, and a luminance of the first area A1′ in the second mode, may be different from each other. For example, the luminance of the first area A1′ in the first mode may be higher than the luminance of the first area A1′ in the second mode. Accordingly, the quality of an image displayed by the display panel 110 may be relatively deteriorated.

Referring to FIG. 11, a luminance of the first area A1′ in the first mode and a luminance of the first area A1′ in the second mode may be the same. For example, the luminance corrector 160 (see FIG. 1) may correct the (1_2)th pixel PX1_2 and the (2_1)th pixel PX2_1. In other words, the luminance corrector 160 may generate compensation data CD such that the data driver 130 or the data distributor 150 increases a luminance of light expressed by the (1_2)th pixel PX1_2 and the (2_1)th pixel PX2_1, and the luminance of light expressed by the (1_2)th pixel PX1_2 and the (2_1)th pixel PX2_1 of the display panel 110 may be increased. Accordingly, the luminance of the first area A1′ in the first mode and the luminance of the first area A1′ are the same, and the quality of an image displayed by the display panel 110 can be relatively improved.

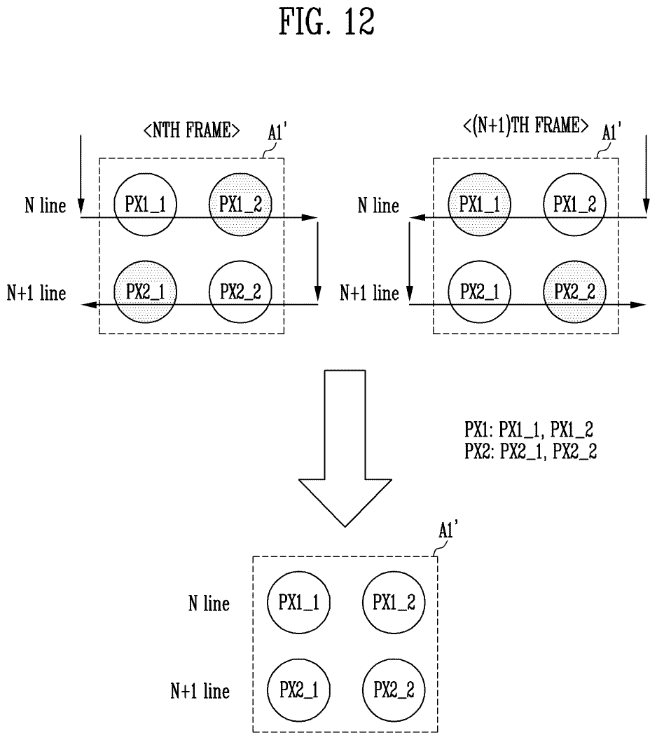

FIG. 12 is a diagram illustrating an order in which a data signal is applied to the pixels of the first area for each frame and the first area viewed by the user of the display device in accordance with one or more embodiments of the present disclosure.

Referring to FIG. 12, in an nth frame as a selected one frame, a data signal may be applied to the first pixels PX1 located on the nth horizontal line, and then may be applied to the second pixels PX2 located on the (n+1)th horizontal line. In the nth frame, the luminance of light output from the (1_2)th pixel PX1_2 and the (2_1)th pixel PX2_1 may be relatively low.

The data distributor 150 (see FIG. 3) may supply a data signal to the first pixels PX1 and the second pixels PX2 in an (n+1)th frame in a direction opposite to a direction in which the data distributor 150 supplies the data signal to the first pixels PX1 and the second pixels PX2 in the nth frame. For example, the data distributor 150 may change a time at which the data signal is supplied, and may change an order in which the data signal is supplied, based on the control signal of the timing controller 140 (see FIG. 1). Accordingly, the data distributor 150 may change the direction in which the data distributor 150 supplies the data signal to the first pixels PX1 and the second pixels PX2 in the (n+1)th frame, and the luminance of light output from the (1_1)th pixel PX1_1 and the (2_2)th pixel PX2_2 may become low.

Luminances of an image that is output from the first pixels PX1 and the second pixels PX2, and that is viewed by the user of the display device 100 (see FIG. 1), may be uniform. For example, the data distributor 150 may alternately change, for each frame, the direction in which the data distributor 150 supplies the data signal to the first pixels PX1 and the second pixels PX2. Accordingly, a risk can be reduced or prevented that the quality of an image will be deteriorated as luminances of light, which are expressed by one pixel of the first area A1 (e.g., the (1_1)th pixel PX1_1 in the nth frame) and another pixel of the first area A1 (e.g., the (1_2)th pixel PX1_2 in the nth frame) are different from each other, and an optimum image can be displayed to the user of the display device 100.

The data distributor 150 may alternately change, for each frame, the direction in which the data distributor 150 supplies the data signal to the first pixels PX1 and the second pixels PX2, and an emission luminance of at least one pixel among the first pixels PX1 and PX2 may be corrected according to the luminance corrector 160. In other words, the luminance corrector 160 may correct an emission luminance of the (1_2)th pixel PX1_2 and the (2_1)th pixel PX2_1 in the nth frame, and may correct an emission luminance of the (1_1)th pixel PX1_1 and the (2_2)th pixel PX2_2 in the (n+1)th frame. Accordingly, the display device 100 can display an image having relatively further improved quality.

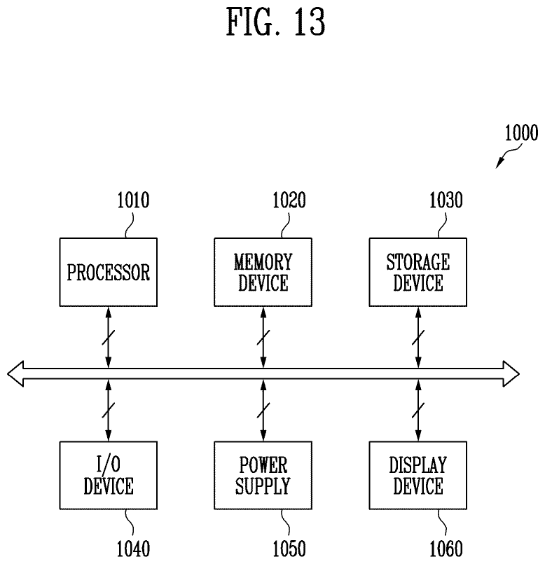

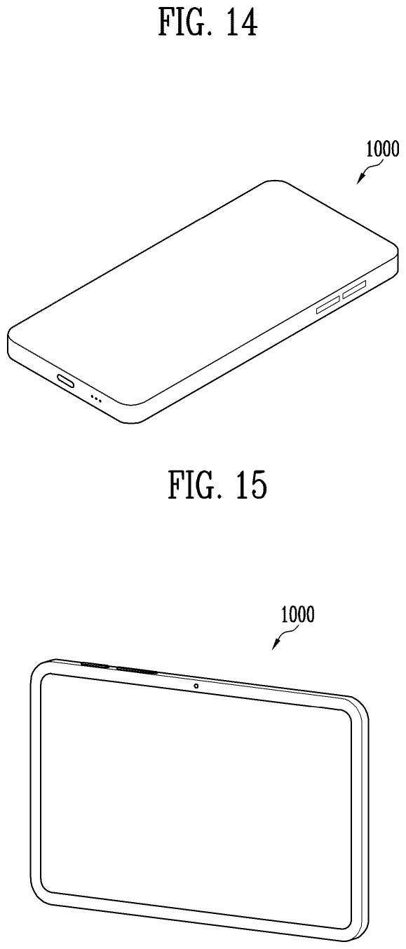

FIG. 13 is a block diagram illustrating an electronic device in accordance with embodiments of the present disclosure. FIG. 14 is a view illustrating an example in which the electronic device shown in FIG. 13 is implemented as a smartphone. FIG. 15 is a view illustrating an example in which the electronic device shown in FIG. 13 is implemented as a tablet PC.

Referring to FIGS. 13 to 15, an electronic device 1000 may include a processor 1010, a memory device 1020, a storage device 1030, an input/output (I/O) device 1040, a power supply 1050, and a display device 1060. The display device 1060 may be the display device 100 shown in FIG. 1. Also, the electronic device 1000 may further include several ports capable of communicating with a video card, a sound card, a memory card, a USB device, and the like, or communicating with other systems. In one or more embodiments, as shown in FIG. 14, the electronic device 1000 may be implemented as a smartphone. In one or more embodiments, as shown in FIG. 15, the electronic device 1000 may be implemented as a tablet PC. However, this is merely illustrative, and the electronic device 1000 is not limited thereto. For example, the electronic device 1000 may be implemented as a mobile phone, a video phone, a smart pad, a smart watch, a vehicle navigation system, a computer monitor, a notebook computer, a head-mounted display device, or the like.

The processor 1010 may perform specific calculations or tasks. In some embodiments, the processor 1010 may be a microprocessor, a central processing unit, an application processor, or the like. The processor 1010 may be connected to other components through an address bus, a control bus, a data bus, and the like. In some embodiments, the processor 1010 may be connected to an extension bus, such as a peripheral component interconnect (PCI) bus.

The memory device 1020 may store data suitable for an operation of the electronic device 1000. For example, the memory device 1020 may include a nonvolatile memory device, such as an Erasable Programmable Read-Only Memory (EPROM) device, an Electrically Erasable Programmable Read-Only Memory (EEPROM) device, a flash memory device, a Phase Change Random Access Memory (PRAM) device, a Resistance Random Access Memory (RRAM) device, a Nano Floating Gate Memory (NFGM) device, a Polymer Random Access Memory (PoRAM) device, a Magnetic Random Access Memory (MRAM) device, or a Ferroelectric Random Access Memory (FRAM) device, and/or a volatile memory device, such as a Dynamic Random Access Memory (DRAM) device, a Static Random Access Memory (SRAM) device, or a mobile DRAM device.

The storage device 1030 may include a Solid State Drive (SSD), a Hard Disk Drive (HDD), a Compact Disc Read Only Memory (CD-ROM), and the like.

The I/O device 1040 may include an input means, such as a keyboard, a keypad, a touch screen, or a mouse, and an output means, such as a speaker or a printer. In some embodiments, the display device 1060 may be included in the I/O device 1040.

The power supply 1050 may supply power suitable for an operation of the electronic device 1000. For example, the power supply 1050 may be a power management integrated circuit (PMIC).

The display device 1060 may display an image corresponding to visual information of the electronic device 1000. The display device 1060 may be an organic light-emitting display device or a quantum dot light-emitting display device, but the present disclosure is not limited thereto. The display device 1060 may be connected to other components through the buses or another communication link. The display device 1060 shown in FIG. 13 may be described like the display device 100 shown in FIG. 1.

In the display device and the electronic device in accordance with the present disclosure, the quality of an image displayed by the display device can be improved by compensating for a luminance difference that unintendedly occurs according to a charging deviation of a data signal between a plurality of pixels.

Embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, aspects described in connection with some embodiments may be used singly or in combination with aspects described in connection with other embodiments unless otherwise specifically indicated. Accordingly, it will be understood by those of skill in the art that various changes in form and details may be made without departing from the spirit and scope of the present disclosure as set forth in the following claims, with functional equivalents thereof to be included therein.

What is claimed is:

1. A display device comprising:
a display panel comprising pixels arranged in a first direction;
a timing controller configured to generate output data based on input image data;
a data driver configured to convert the output data into a data signal, and to output the data signal to at least one output line;
a data distributor configured to supply the data signal to data lines connected to the display panel based on any one of a first control signal or a second control signal supplied from the timing controller; and
a luminance corrector configured to generate compensation data for correcting one of the pixels supplied with the data signal relatively late.

2. The display device of claim 1, wherein the pixels comprise first pixels comprising:
a (1_1)th pixel configured to be supplied with the data signal corresponding to the first control signal; and
a (1_2)th pixel configured to be supplied with the data signal corresponding to the second control signal that is different from the first control signal.

3. The display device of claim 2, wherein the (1_2)th pixel comprises the one of the pixels supplied with the data signal relatively late as compared with the (1_1)th pixel.

4. The display device of claim 3, wherein the pixels further comprise second pixels sequentially arranged in the first direction, and
wherein, in one frame, the second pixels are configured to be supplied with the data signal in a same direction as a direction in which the first pixels are configured to be sequentially supplied with the data signal.

5. The display device of claim 4, wherein the second pixels comprise:
a (2_1)th pixel configured to be supplied with the data signal corresponding to the first control signal; and
a (2_2)th pixel configured to be supplied with the data signal, which corresponds to the second control signal, relatively late as compared with the (2_1)th pixel.

6. The display device of claim 5, wherein the (1_1)th pixel and the (2_1)th pixel are adjacent to each other in a second direction crossing the first direction, and
wherein the (1_2)th pixel and the (2_2)th pixel are adjacent to each other in the second direction.

7. The display device of claim 6, wherein, in a next frame after the one frame, the first pixels and the second pixels are configured to be sequentially supplied with the data signal in a direction that is opposite to the direction in which the first pixels and the second pixels are configured to be supplied with the data signal in the one frame.

8. The display device of claim 6, wherein the (1_2)th pixel and the (2_2)th pixel are configured to be turned off in a first mode, and
wherein the (1_1)th pixel and the (2_1)th pixel are configured to be turned off in a second mode that is different from the first mode.

9. The display device of claim 8, wherein the luminance corrector is configured to control luminances of light emitted by the pixels in the first mode and in the second mode to be substantially equal.

10. The display device of claim 3, wherein the pixels further comprise second pixels sequentially arranged in the first direction, and
wherein, in one frame, the second pixels are configured to be supplied with the data signal in a direction opposite to a direction in which the first pixels are configured to be sequentially supplied with the data signal.

11. The display device of claim 10, wherein the second pixels comprise:
a (2_2)th pixel configured to receive the data signal corresponding to the second control signal; and
a (2_1)th pixel configured to receive the data signal, which corresponds to the first control signal, relatively late as compared with the (2_2)th pixel.

12. The display device of claim 11, wherein the (1_1)th pixel and the (2_1)th pixel are adjacent to each other in a second direction crossing the first direction, and
wherein the (1_2)th pixel and the (2_2)th pixel are adjacent to each other in the second direction.

13. The display device of claim 12, wherein, in a next frame after the one frame, the first pixels and the second pixels are configured to be sequentially supplied with the data signal in a direction opposite to the direction in which the first pixels and the second pixels are configured to be supplied with the data signal in the one frame.

14. An electronic device comprising:
a processor configured to provide input image data; and
a display device configured to display an image based on the input image data, and comprising:
a display panel comprising pixels arranged in a first direction;
a timing controller configured to generate output data based on input image data;
a data driver configured to convert the output data into a data signal, and to output the data signal to at least one output line;
a data distributor configured to supply the data signal to data lines, which are connected to the display panel, based on any one of a first control signal or a second control signal supplied from the timing controller; and
a luminance corrector configured to generate compensation data for correcting one of the pixels supplied with the data signal relatively late.

15. The electronic device of claim 14, wherein the pixels comprise first pixels comprising:
a (1_1)th pixel configured to be supplied with the data signal, corresponding to the first control signal; and
a (1_2)th pixel configured to be supplied with the data signal, corresponding to the second control signal different from the first control signal.

16. The electronic device of claim 15, wherein the (1_2)th pixel is configured to receive the data signal relatively late as compared with the (1_1)th pixel.

17. The electronic device of claim 16, wherein the pixels further comprise second pixels that are sequentially arranged in the first direction, and that are configured to be sequentially supplied with the data signal according to an order in which the second pixels are arranged in a same direction as a direction in which the first pixels are configured to be supplied with the data signal in one frame.

18. The electronic device of claim 17, wherein the second pixels comprise:
a (2_1)th pixel configured to receive the data signal corresponding to the first control signal; and
a (2_2)th pixel configured to receive the data signal, which corresponds to the second control signal, relatively late as compared with the (2_1)th pixel.

19. The electronic device of claim 18, wherein, in a next frame after the one frame, the first pixels and the second pixels are configured to be sequentially supplied with the data signal in a direction opposite to a direction in which the first pixels and the second pixels are configured to be supplied with the data signal in the one frame.
